(19) United States
(12) Patent Application Publication
(10) Pub. No.: US 2017/0122519 A1
(43) Pub. Date: May 4, 2017

(54) LIGHT GUIDE MODULE FOR A VEHICLE LAMP AND METHOD OF MANUFACTURING SUCH A LIGHT GUIDE MODULE

(71) Applicants: Hyundai Motor Europe Technical Center GmbH, Russelsheim (DE); Hyundai Motor Company, Seoul (KR); Kia Motors Corporation, Seoul (KR)

(72) Inventors: Achim FREIDING, Hattersheim (DE); Miroslav KROPAC, Mainz-Finthen (DE)

(73) Assignees: Hyundai Motor Europe Technical Center GmbH, Russelsheim (DE); Hyundai Motor Company, Seoul (KR); Kia Motors Corporation, Seoul (KR)

(21) Appl. No.: 14/975,009

(22) Filed: Dec. 18, 2015

(30) Foreign Application Priority Data
Nov. 4, 2015 (DE) 10 2015 221 672.1

(51) Int. Cl. F21S 8/10

(52) U.S. Cl. CPC F21S 48/1241; F21S 48/225; F21S 48/2268

(57) ABSTRACT

A light guide module for a vehicle lamp may include a one-piece body including an in-coupling part formed so light of at least one external light source is coupled into the in-coupling part, a light-transmitting part formed adjacent to the in-coupling part such that the light coupled into the in-coupling part is transmitted by total internal reflection through the light-transmitting part away from the in-coupling part, a partially-transmitting part formed adjacent to the light-transmitting part such that the light transmitted through the light-transmitting part is partially transmitted by total internal reflection through the partially-transmitting part away from the light-transmitting part and is partially emitted on at least one light-emitting partial area of at least one side surface of the partially-transmitting part, and an out-coupling part formed adjacent to the partially-transmitting part such that the light transmitted through the partially-transmitting part is emitted on an out-coupling surface of the out-coupling part.

### CROSS-REFERENCE TO RELATED APPLICATION

The present application claims priority to German Patent Application No. 102015221672.1 filed Nov. 4, 2015, the entire contents of which is incorporated herein for all purposes by this reference.

### BACKGROUND OF THE INVENTION

Field of the Invention

The present invention relates to a light guide module for a vehicle lamp and to a lamp for a vehicle. Moreover, the present invention also relates to a method of manufacturing a light guide module for a vehicle lamp and to a method of manufacturing a lamp for a vehicle.

Description of Related Art

It is known from the prior art to use light guides as a basis for lamps to replace conventional lamps that typically comprise an incandescent bulb and a reflector together with a lens system for shaping and directing an output beam of such a conventional lamp. Conventional lamps of that type are comparatively inefficient and bulky, and they are often not aesthetically pleasing. In addition, a bulb position of the bulb of such a conventional lamp is usually visible through the lens system, which causes “hot spots” and a generally non-uniform appearance of the output beam.

An additional reason for the increasing interest in light guides as the basis for lamps is that they make it possible to use light-emitting diodes (LED), or other solid state light-emitting devices as light sources. Light-emitting diodes are becoming increasingly reliable and available at lower costs. Furthermore light-emitting diodes offer particular advantages as light sources, because they take-up only a small amount of space and are highly efficient in comparison with incandescent light sources.

The use of a light guide for a vehicle lamp is described for instance in the prior art. The described light guide has an in-coupling surface so that light of an external light source can be coupled into the light guide. The light guide also has edges, wherein several out-coupling structures are formed close to each of the edges of the light guide. The prior art further suggests to use several of the light guides within one tail lamp of a vehicle, which are arranged at an inner side of a glass panel of the tail lamp.

However, the tail lamp with the light guides of the prior art comprise a relative high number of components. This increases its manufacturing costs. Furthermore, many users consider its light signal as being unattractive.

It is therefore the object of the present invention to provide a lamp that provides a more attractive light signal.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a light guide module for a vehicle lamp, the lamp for the vehicle, a method of manufacturing the light guide module for the vehicle lamp and a method of manufacturing the vehicle to provide a lamp that provides a more attractive light signal.

Various aspects of the present invention are additionally directed to providing advantageous opportunities for creating an optical module that combines functionality and decorated styling to provide a unique appearance and a good signal function for lamps. These lamps, that may be used as a signal light, a head light, a tail light, a stop light, a turn signal, a reversing light, a rear fog lamp and/or a position light, for instance, provide a bright signal even when they comprise only a minimum number of light sources, such as light-emitting diodes (LED). As will be explained by given examples below, the inventive lamps provide attractive light signals. As these light signals can also be detected and understood by another person quickly, the present invention also increases a standard of security of any vehicle equipped with at least one of the inventive lamps.

Furthermore, various aspects of the present invention are directed to providing the advantage that the out-coupling surface of the out-coupling part of the inventive light guide module may be used as the outer surface of the vehicle lamp equipped with the light guide module. Thus, the present invention also decreases the parts of a vehicle lamp. Moreover, the assembly simplification of the inventive vehicle lamp facilitates its manufacturing and decreases its cost.

Additionally, various aspects of the present invention provide that the inventive light guide module can be manufactured by using a simple molding technology (2K or 3K). The invention thus uses the potential of modern molding technologies for innovative approaches in order to create a unique appearance compatible with price constrains via reduction of assembly parts and elimination of electronic components.

The above-mentioned advantages are also provided by a lamp for a vehicle that comprises such a light guide module. The lamp may also comprise at least one light source arranged adjacent to the in-coupling part of the light guide module on a side of the in-coupling part facing away from the out-coupling part of the light guide module and/or a housing, which surrounds the light guide module and the at least one light source at least partially. The at least one light source may be a light-emitting diode (LED), for instance.

According to various aspects of the present invention, a light guide module for a vehicle lamp may include a one-piece body including an in-coupling part formed so that light of at least one external light source is coupled into the in-coupling part, a light-transmitting part formed adjacent to the in-coupling part such that the light coupled into the in-coupling part is transmitted by total internal reflection through the light-transmitting part away from the in-coupling part, a partially-transmitting part formed adjacent to the light-transmitting part such that the light transmitted through the light-transmitting part is partially transmitted by total internal reflection through the partially-transmitting part away from the light-transmitting part and is partially emitted on at least one light-emitting partial area of at least one side surface of the partially-transmitting part, and an out-coupling part formed adjacent to the partially-transmitting part such that the light transmitted through the partially-transmitting part is emitted on an out-coupling surface of the out-coupling part.

A perimeter of the light guide module may increase along a direction from the in-coupling part to the out-coupling part.

The increase of the perimeter may further increase the attractiveness of the light signal, as will be further explained below.

The one-piece body may include a bottom and a side wall structure, in which the side wall structure frames at least partially an inner volume, and at least a part of the bottom may be formed as the in-coupling part, a first part of the side wall structure may be formed as the light-transmitting part, a second part of the side wall structure may be formed as the partially-transmitting part and a third part of the side wall structure, which is facing away from the bottom, may be formed as the out-coupling part.

Thus, it is possible to form the light guide module as an iconic 3D light guide module. Such an iconic 3D light guide module provides attractive light signals, as will be explained further below.

A front cover may be arranged within the inner volume framed at least partially by the side wall structure such that at least a part of a side of the in-coupling part that is directed to the out-coupling part is covered by the front cover.

Thus, it is possible to cover the at least one external light source with the front cover to avoid the disability of the at least one external light source from the outside. This inhibits also the appearance of “hot spots”. (The increase of the perimeter of the light guide module may also facilitate the arrangement of the front cover in a way that the in-coupling part is at least partially covered.)

For instance, the side wall structure may be U-shaped in a cross sectional area parallel to the bottom. However, the feasibility of the light guide module is not restricted to the form of the side wall structure described here.

The side wall structure may be U-shaped in a cross sectional area parallel to the bottom.

At least one of at least one optical prism and at least one grain may be formed in the light-transmitting part such that the light transmitted through the light-transmitting part is distributed homogeneously into the partially-transmitting part.

It is thus easy to ensure a homogenous distribution of the light transmitted into the partially-transmitting part even when the perimeter of the side wall structure increases in the direction from the in-coupling part to the out-coupling part.

At least one decorative element may be formed as the at least one light-emitting partial area of the at least one side surface of the partially-transmitting part such that the light transmitted through the light-transmitting part is partially emitted on the at least one decorative element.

A variety of different forms are possible for the at least one decorative element. Examples for the at least one decorative element, which ensure an attractive light signal, are given below.

The out-coupling surface of the out-coupling part may be at least partially formed of or covered with a light-scattering material.

A lot of inexpensive light-scattering materials may be used for the out-coupling surface of the out-coupling part to ensure an attractive light signal of a lamp equipped with this embodiment of the light guide module. However, the same effect may be realized by using at least one clear translucent material and at least one additional (light-scattering and/or light directing) optic for the out-coupling part.

At least one of the light-transmitting part and the partially-transmitting part are at least partially formed of a clear translucent material.

A variety of inexpensive clear translucent materials may be used for the light-transmitting part and/or the partially-transmitting part of the light guide module.

According to various embodiments of the present invention, a lamp for a vehicle may include the light guide module previously described, at least one light source arranged adjacent to the in-coupling part of the light guide module on a side of the in-coupling part that is directed away from the out-coupling part of the light guide module, and a housing, surrounding the light guide module and the at least one light source at least partially.

The lamp may include a signal light, a head light, a tail light, a stop light, a turn signal, a reversing light, a rear fog lamp or a position light. However, the present invention is not restricted to a certain type of the lamp with such a light guide module.

According to various embodiments of the present invention, a method of manufacturing a light guide module for a vehicle lamp may include forming a one-piece body with an in-coupling part, a light-transmitting part adjacent to the in-coupling part, a partially-transmitting part adjacent to the light-transmitting part and an out-coupling part adjacent to the partially-transmitting part, in which the one-piece body may be formed so that light of at least one external light source is coupled into the later in-coupling part, the light coupled into the in-coupling part may be transmitted by total internal reflection through the later light-transmitting part away from the in-coupling part, the light transmitted through the light-transmitting part is partially transmitted by total internal reflection through the later partially-transmitting part away from the light-transmitting part and may be partially emitted on at least one light-emitting partial area of at least one side surface of the partially-transmitting part, and the light transmitted through the partially-transmitting part may be emitted on an out-coupling surface of the out-coupling part.

The one-piece body may be formed with a bottom and a side wall structure, in which the side wall structure frames at least partially an inner volume, and at least a part of the bottom may be formed as the in-coupling part, a first part of the side wall structure may be formed as the light-transmitting part, a second part of the side wall structure may be formed as the partially-transmitting part and a third part of the side wall structure, which is facing away from the bottom, may be formed as the out-coupling part.

A front cover may be arranged within the inner volume framed at least partially by the side wall structure such that at least a part of a side of the in-coupling part that is directed to the out-coupling part is covered by the front cover

According to various embodiments of the present invention, a method of manufacturing a lamp for a vehicle may include manufacturing a light guide module according to the methods previously described, arranging the at least one light source adjacent to the in-coupling part of the light guide module on a side of the in-coupling part that is directed away from the out-coupling part of the light guide module, in which the light guide module and the at least one light source may be at least partially surrounded by a housing of the lamp.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1A, FIG. 1B, and FIG. 1C are two schematic cross-sectional views of an exemplary lamp for a vehicle and a schematic front view of the exemplary lamp according to the present invention.

FIG. 2A, FIG. 2B, and FIG. 2C are an exploded diagram of an exemplary lamp for a vehicle, a schematic front view of a printed circuit board and a light guide module of the exemplary lamp and a schematic front view of the exemplary lamp according to the present invention.

FIG. 3, FIG. 4, and FIG. 5 show light signals of the exemplary lamp according to the present invention.

FIG. 6 is a flow chart of a method of manufacturing an exemplary lamp for a vehicle.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

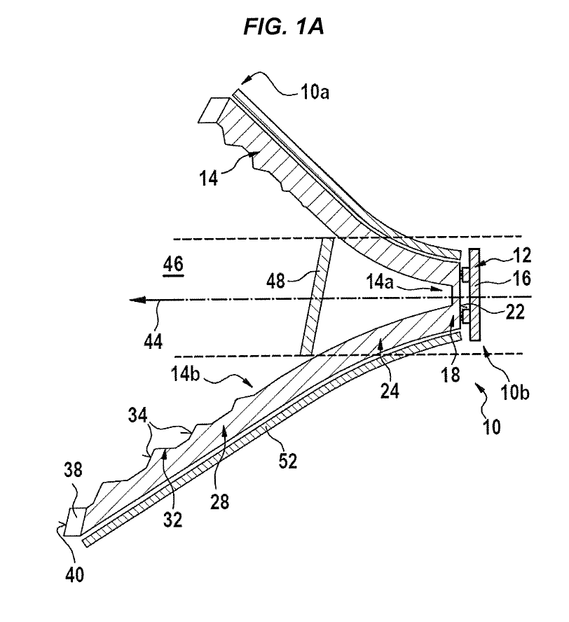

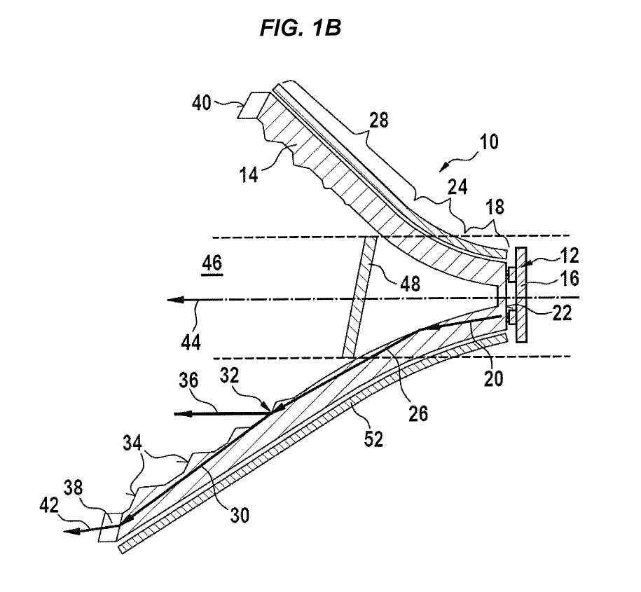

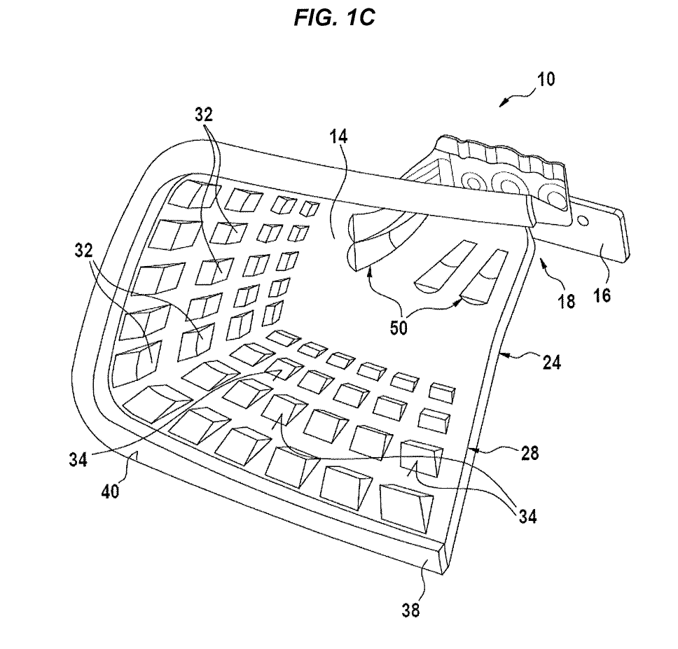

FIG. 1A to 1C are two schematic cross-sectional views of various embodiments of the lamp and a schematic front view of the lamp.

The lamp 10 of the various embodiments of FIG. 1A to 1C may be a signal lamp/signal light. The lamp 10 may be a lamp 10 for a vehicle (a vehicle-light). The lamp 10 may be a signal light, a head light, a tail light, a stop light, a turn signal, a reversing light, a rear fog lamp or a position light, for instance. The lamp 10 may have a light-emitting side 10a that emits a light signal of the lamp 10, while a contact side 10b of lamp 10 may contact an object equipped with the lamp 10, for instance a vehicle equipped with the lamp 10. However, a feasibility of the lamp 10 is not restricted to a certain form or a certain use of the lamp 10.

The lamp 10 shown in FIGS. 1A to 1C has at least one light source 12 and a light guide module 14. The at least one light source 12 is arranged extern to the light guide module 14. The at least one light source 12 may be a solid state light-emitting device 12, for instance. In various embodiments, the at least one light source 12 is at least one light-emitting diode (LED) 12. Thus, the advantages of light-emitting diodes 12, as for example their increased reliability, their small volumes and their low production costs, may be used for the lamp 10. However, the feasibility of the lamp 10 is not restricted to the use of a certain type of light source for the at least one light source 12.

In the various embodiments of FIGS. 1A to 1C the at least one light source 12 is at least one LED 12. A number, color and power of the at least one LED 12 may be chosen with regard to the intended functionality of the lamp 10. The at least one LED 12 is arranged on a (centralized/rigid) printed circuit board (PCB) 16. The PCB 16 with the at least one LED 12 are in various embodiments the only electronics of the lamp 10. This decrease of the number of electronics of the lamp 10 facilitates a manufacturing of the lamp 10 and decreases its manufacturing costs significantly.

The light guide module 14 is formed as a one-piece body. The light guide module 14 comprises an in-coupling part 18 formed so that light of the at least one (external) light source 12 is coupled to the in-coupling part 18. This is shown by an arrow 20 in FIG. 1B. In various embodiments, the at least one light source 12 is arranged adjacent to the in-coupling part 18 of the light guide module 14. The at least one light source 12 may be arranged close to an in-coupling surface 22 of the in-coupling part 18. Contrary to many conventional lamps, the lamp 10 does not need a coupling-in lens. This further decreases the costs of the lamp 10.

The light guide module 14 also includes a light-transmitting part 24, which is formed adjacent to the in-coupling part 18. The light-transmitting part 24, which may also be called a light-aiming part 24, is formed in a way that (almost all) the light coupled into the in-coupling part 18 is transmitted by total internal reflection through the light-transmitting part 24 away from the in-coupling part 18. This is shown by the arrows 20 and 26 in FIG. 1B.

The light guide module 14 also has a partially-transmitting part 28, which is formed adjacent to the light-transmitting part 24. The partially-transmitting part 28 may also be called a decorative part 28 of the light guide module 14, because its presence increases the attractiveness of a light signal of the lamp 10 significantly. The partially-transmitting part 28 is formed in a way that the light transmitted through the light-transmitting part 24 is partially transmitted by total internal reflection through the partially-transmitting part 28 away from the light-transmitting part 24. This is shown by the arrows 26 and 30 in FIG. 1B. However, the light transmitted through the light-transmitting part 24 is also partially emitted on at least one light-emitting partial area 32 of at least one side surface 34 of the partially-transmitting part 28. Thus, while the light-transmitting part 24 hardly emits any light, the at least one light-emitting partial area 32 of the partially-transmitting part 28 provides at least one light spot to the light signal of the lamp 10. This is shown by an arrow 36 in FIG. 1B. The at least one light spot provided by the at least one light-emitting partial area 32 of the partially-transmitting part 28 makes the light signal of the lamp 10 more attractive, as is further explained in more details below.

Furthermore, an out-coupling part 38 of the light guide module 14 is formed adjacent to the partially-transmitting part 28. The out-coupling part 38 is formed in a way that (almost all) the light transmitted through the partially-transmitting part 28 is emitted on an out-coupling surface 40 of the out-coupling part 38. This is shown by an arrow 42 in FIG. 1B. In various embodiments, the out-coupling surface 40 of the out-coupling part 38 is facing away from the at least one light source 12 and/or the in-coupling part 18. Moreover, the out-coupling surface 40 of the out-coupling part 38 may be oriented towards the light-emitting side 10a of the lamp 10.

In various embodiments, most of the light running via the partially-transmitting part 28 reaches the out-coupling part 38, even though light is emitted on the at least one light-emitting partial area 32 on the at least one side surface 34 of the partially-transmitting part 28. In various embodiments, only the out-coupling part 38 is so designed that (almost) all the light reaching the out-coupling part 38 is out-coupled/emitted (on the out-coupling surface 40).

No special optics are required for the out-coupling part 38. Thus, no additional optical elements (such as flutes or prisms or output edges) are needed to direct the light out-coupled on the out-coupling surface 40. In various embodiments, no glass panel is arranged at the light-emitting side 10a of the lamp 10. Instead, the at least one side surface 34 of the partially-transmitting part 28 with the at least on light-emitting partial area 32 and the out-coupling surface 40 may form parts of the light-emitting side 10a of the lamp 10.

The light guide module 14 with the parts 18, 24, 28 and 38 may be formed of at least one translucent plastic and/or at least one partially-translucent plastic, for instance. The in-coupling part 18 may be made of at least one clear translucent material and/or at least one light-scattering (milky) translucent material. For the light-transmitting part 24 and/or the partially-transmitting part 28 of the light guide module 14 at least one clear translucent material is used in various embodiments. However, it is sufficient when the light transmitting part 24 and/or the partially-transmitting part 28 are formed only partially of the at least one clear translucent material. In various embodiments, the out-coupling surface 40 of the out-coupling part 38 is (at least partially) formed of or covered with a light-scattering material. Also, a variety of different light-scattering (milky) translucent materials may be used to form the out-coupling part 38. As the out-coupling part 38/its out-coupling surface 40, in various embodiments, is made of at least one light-scattering (milky) translucent material, the light emitted on the out-coupling surface 40 will be spread. Thus, an inhomogeneity of the light emitted on the out-coupling surface 40 is avoided. Moreover, light values of tail-signals/stop-signals-regulations can be ensured. However, a feasibility of the light guide module 14 is not restricted to a certain material of the light guide module 14 within the parts 18, 24, 28 and 38.

To ensure the total internal reflection of (almost all) the light coupled into the in-coupling part 18 within the light-transmitting part 24 (so that the light is transmitted through the light-transmitting part 24 away from the in-coupling part 18), an (entire) external surface of the light-transmitting part 24, in various embodiments, is covered with/formed of at least one material suited for total internal reflection. Furthermore, to ensure that the light transmitted through the light-transmitting part 24 is partially transmitted by total internal reflection through the partially-transmitting part 28 away from the light-transmitting part 24, (with the exception of the at least one light-emitting partial area 32) a rest of an (entire) external surface of the partially-transmitting part 28 is in various embodiments also covered with/formed of at least one material suited for total internal reflection. Other external surfaces of the in-coupling part 18 and/or the out-coupling part 38 may also be covered with/formed of at least one material suited for total internal reflection. A variety of different materials may cause the advantageous total internal reflection of the light transmitted through the light-transmitting part 24 and of the light transmitted partially through the partially-transmitting part 28. The feasibility of the light guide module 14 is not restricted to a certain material for total internal reflection. Therefore, no example for the at least one material suited for total internal reflection is given here.

In the various embodiments of FIGS. 1A to 1C, the light guide module 14 has such a form that a perimeter (an outer perimeter) of the light guide module 14 increases along a direction 44 from the in-coupling part 18 to the out-coupling part 38. Moreover, an area of the in-coupling surface 22 of the in-coupling part 18 may be smaller than an area of the out-coupling surface 40 of the out-coupling part 38 and/or may be smaller than a total area of the out-coupling surface 40 and another area at least partially framed by the out-coupling surface 40. The interaction of the at least one light source/LED 12 with the light guide module 14 ensures in all these cases that the light emitted from the at least one light source/LED 12 is transmitted homogeneously from the in-coupling surface 22 through the light guide module 14 to the out-coupling surface 40. Thus, it is possible to illuminate even a relative broad area of the light-emitting side 10a of the lamp 10 homogenously (to fulfill legal requirements), even though only a relative low number of light sources/LEDs 12 are used. The combination of the relative low number of light sources/LEDs 12 with the light guide module 10 thus opens an area for new optical concepts in the field of automotive signal lighting.

Furthermore, the light guide module 14 may be formed in a way that the at least one side surface 34 of the partially-transmitting part 28 with the at least one light-emitting partial area 32 is visible for a person looking on the light-emitting side 10a of the lamp 10. In various embodiments, the at least one convex side surface 34 with the at least one light-emitting partial area 32 is oriented at least partially toward the light-emitting side 10a of the lamp 10. For instance, the at least one side surface 34 of the partially-transmitting part 28 with the at least one light-emitting partial area 32 (and/or an adjacent external surface of the light-transmitting part 24) may have a convex form. This ensures that the at least one light-emitting partial area 32 of the partially-transmitting part 28 (its at least one light spot) is visible for the person looking on the light-emitting side 10a of the lamp 10 (as well as the out-coupling surface 40 of the out-coupling part 38).

In the example of FIGS. 1A to 1C, the one-piece body of the light guide module 14 includes a bottom 14a and a side wall structure 14b. The side wall structure 14b frames at least partially an inner volume 46. At least a part of the bottom 14a is formed as the in-coupling part 18. A first part of the side wall structure 14b is formed as the light-transmitting part 24. A further/second part of the side wall structure 14b is formed as the partially-transmitting part 28. Within the light-transmitting part 24 and/or the partially-transmitting part 28, at least one side wall of the side wall structure 14b may be bent away from the inner volume 46 so that the at least one side surface 34 with the at least one light-emitting partial area 32 is oriented at least partially toward the light-emitting side 10a of the lamp 10. Finally, a rest/third part of the side wall structure 14b, which is facing away from the bottom 14a, is formed as the out-coupling part 38. The light guide module 14 is thus formed as an iconic 3D light guide module 14.

The lamp 10 also has a front cover 48 that is arranged within the inner volume 46 (surrounded at least partially by the side wall structure 14b) in a way that at least a part of a side of the in-coupling part 18 that is directed towards the out-coupling part 38 (or towards on the light-emitting side 10a of the lamp 10) is covered by the front cover 48. (In various embodiments, the at least one light source 12 is arranged on another side of the in-coupling part 18 that is directed away from the out-coupling part 38 of the light guide module 14.) The front cover 48 thus ensures that the person looking on the light-emitting side 10a of the lamp 10 does not look directly on the in-coupling part 18 or on the at least one light source 12. This further improves an attractiveness of the light signal of the lamp 10.

As is shown in FIG. 1C, at least one optical prism 50 is formed in the light-transmitting part 24 in a way that the light transmitted through the light-transmitting part 24 (away from the in-coupling part 18) is distributed homogeneously into the partially-transmitting part 28. However, the same advantage is ensured when at least one grain is formed in the light-transmitting part 24 as an alternative or an addition to the at least one prism 15.

In the example of FIGS. 1A to 1C, at least one decorative element 32 is formed as/at the at least one light-emitting partial area 32 of the at least one side surface 34 of the partially-transmitting part 28 in a way that the light transmitted through the light-transmitting part 24 is partially emitted on the at least one decorative element 32. Thus, the at least one decorative element 32 causes an out-coupling of the light that reaches these decorative elements 32. The at least one decorative element 32 may be designed as at least one prism and/or at least one rib. It may be equipped with at least one surface to scatter light. In various embodiments, a grain structure may be formed on the at least one side surface 34 of the at least one prism and/or rib.

Finally, the lamp 10 shown in FIGS. 1A to 1C is also equipped with a (partially shown) housing 52. The housing 52 surrounds the light guide module 14 and the at least one light source 12 at least partially.

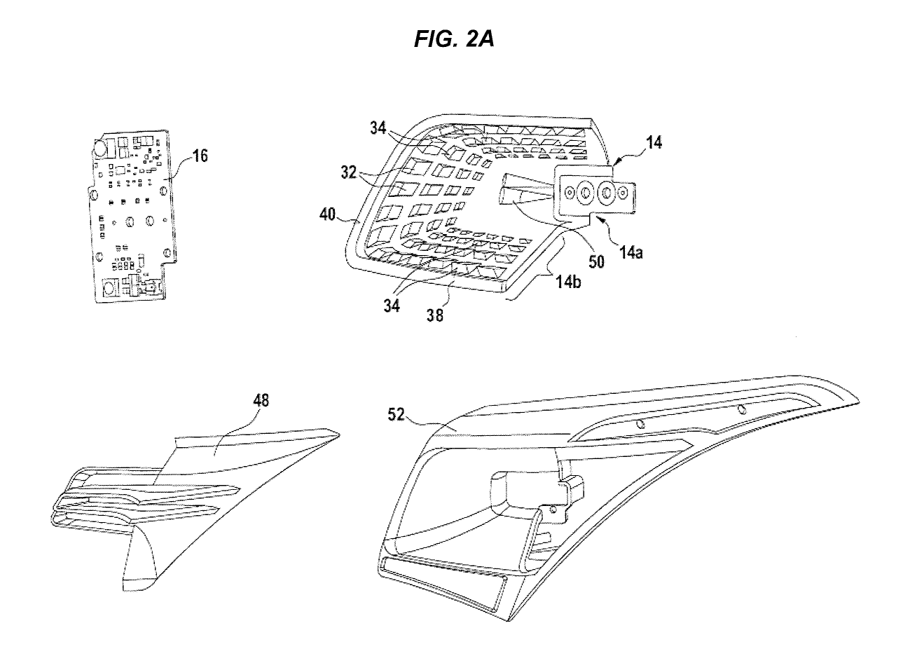

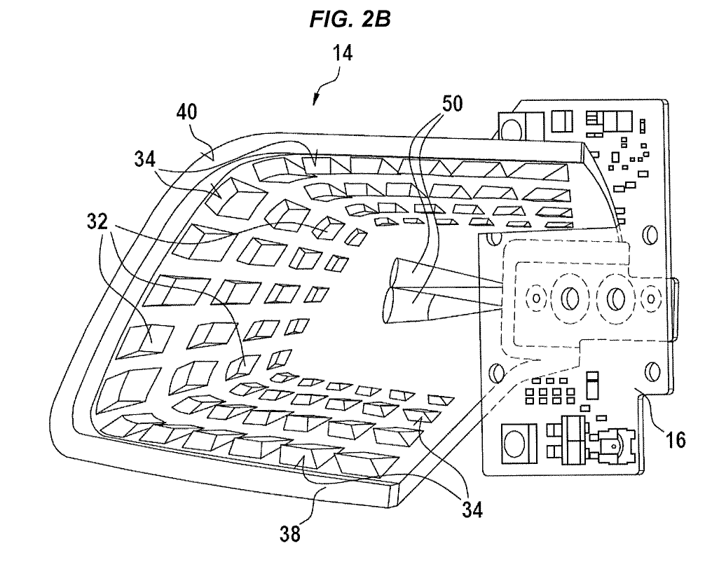

FIGS. 2A to 2C are an explosion diagram of a lamp, a schematic front view of a printed circuit board and the light guide module of the lamp and a schematic front view of the lamp according to various embodiments of the present invention.

The lamp 10 shown in FIG. 2A as an explosion diagram of its printed circuit board (PCB) 16 (with the at least one LED 12), its light guide module 14, its front cover 48 and its housing 52 has all the features of the various embodiments described above. Furthermore, the light guide module 14 has a side wall structure 14b that is U-shaped (c-shaped) in a cross-sectional area parallel to the bottom 14a. Thus, the light guide module 14 has an iconic 3D-shaped design that ensures that its U-shaped (c-shaped) out-coupling surface 40 emits a U-shaped (c-shaped) light strip within its light signal.

FIG. 2B shows the at least one light source/LED 12 (on the PCB 16) placed adjacent to the in-coupling surface 22 of the in-coupling part 18 of the light guide module 14. Thus, the at least one light source/LED 12 is placed in front of the in-coupling part 18 designed to in-couple light from the at least one light source/LED 12 into the light guide module 14 to reach the light-transmitting part 24 of the light guide module 14. (The just one (centralized/rigid) PCB 16 is the cheapest electronic solution for such a lamp 10.)

As in the various embodiments described above, the light-transmitting part 24 is equipped with optics to distribute light homogeneously into the partially-transmitting part 28 of the light guide module 14. These optics may be prisms 50 and/or grains. The partially-transmitting part 28 is equipped with decorative elements 32 to out-couple light reaching these decorative elements 32. However, most of the light running via the partially-transmitting part 28 reaches the out-coupling part 38. The out-coupling part 38 is designed to out-couple the light at its out-coupling surface 40.

In various embodiments, the out-coupling part 38 is made of light-scattering translucent material.

Then, the light guide module 14 and the PCB 16 are inserted into the housing 52. At least a part of a side of the in-coupling part 18 that is directed towards the out-coupling part 38 is covered by the front cover 48 to avoid direct view on the at least one light source/LED 12 to a person looking at the light-emitting side 10a of the lamp 10. The result is shown in FIG. 2C.

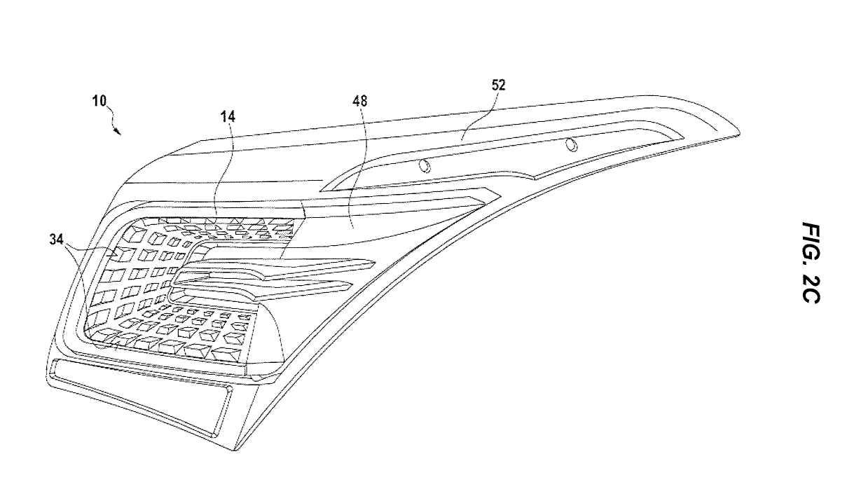

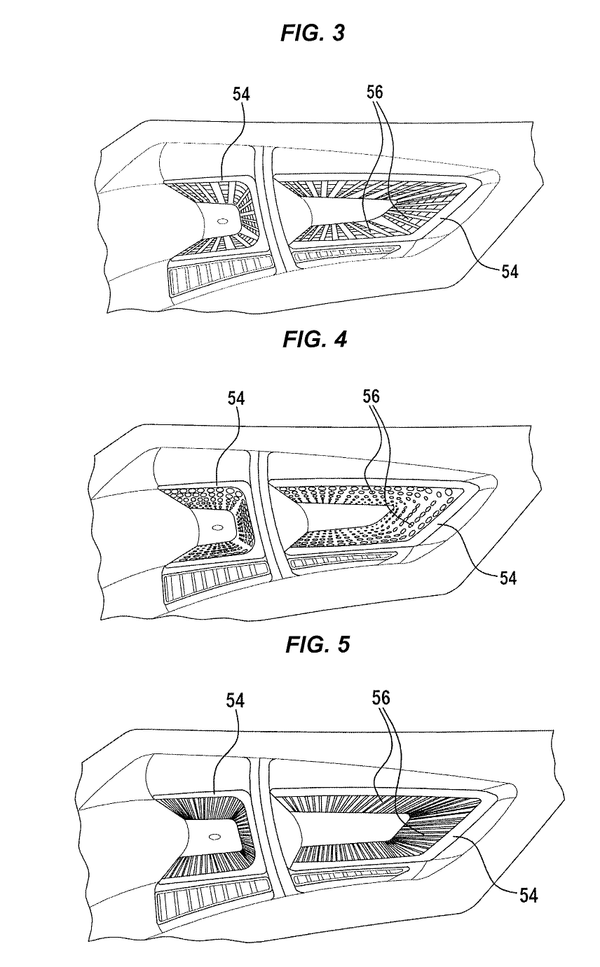

FIGS. 3 to 5 show light signals of various embodiments of the lamp.

The various embodiments of the lamp whose light signals are shown in FIGS. 3 to 5 have all the features of the various embodiments of FIGS. 1A to 1C and FIGS. 2A to 2C described above. The various embodiments of FIGS. 3 to 5 differ only in the form of their light-emitting partial areas 32 of their partially-transmitting parts 28.

Therefore, each of the light signals of FIGS. 3 to 5 has a U-shaped strip 54, with a form corresponding to the form of the out-coupling surface 40 of its light guide module 14. Moreover, each of the light signals also includes a plurality of light spots 56 within an area framed by the U-shaped strip 54. The light spots 56 have different forms due to the different forms of their light-emitting partial areas 32 of their partially-transmitting parts 28. The light spots 56 may look like squares (FIG. 3), circles (FIG. 4) or light strips (FIG. 5).

As can be seen in FIGS. 3 to 5, the light-emitting partial areas 32 (on each partially-transmitting part 28) of each light guide module 14 can be used for styling features, which make the light signals more attractive. Moreover, by using the light-emitting partial areas 32 (on each partially-transmitting part 28) of each light guide module 14 it is possible to give the light signal a depth effect. This depth effect may make sure that the light signal is recognized by other persons sooner than a light signal according to the prior art of a conventional lamp.

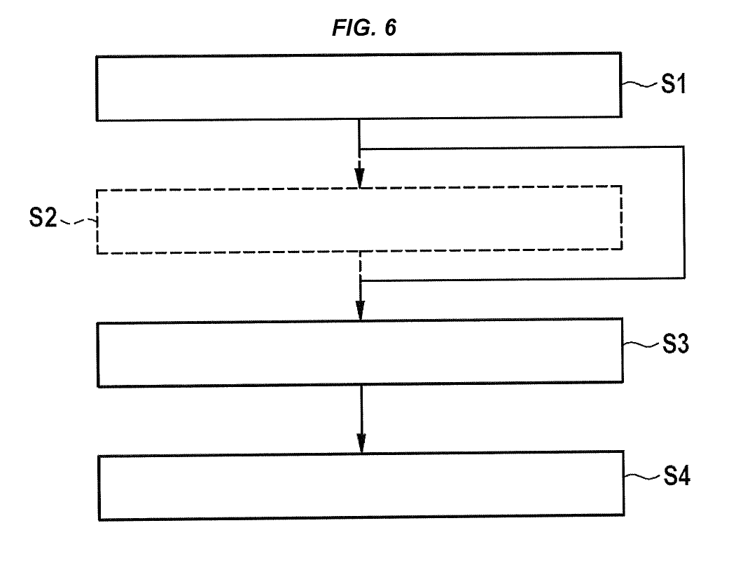

FIG. 6 is a flow chart of various embodiments of the method of manufacturing a lamp for a vehicle.

The method of manufacturing a lamp for a vehicle may be carried out to build any of the above-mentioned various embodiments. However, the application of this method is not restricted to the manufacturing of the above-mentioned various embodiments.

In a method step S1, a light guide module is manufactured. This is done by forming a one-piece body with an in-coupling part, a light-transmitting part adjacent to the in-coupling part, a partially-transmitting part adjacent to the light-transmitting part and an out-coupling part adjacent to the partially-transmitting part. The one-piece body is formed so that light of at least one later (external) light source is coupled into the later in-coupling part, (almost all) the light coupled into the in-coupling part is transmitted by total internal reflection through the later light-transmitting part away from the in-coupling part, the light transmitted through the light-transmitting part is partially transmitted by total internal reflection through the later partially-transmitting part away from the light-transmitting part and is partially emitted on at least one light-emitting partial area of at least one side surface of the partially-transmitting part, and (almost all) the light transmitted through the partially-transmitting part is emitted on an out-coupling surface of the out-coupling part. The light guide module may be manufactured with any of the features of the above-mentioned embodiments. For instance, the one-piece body may be formed with a bottom and a side wall structure, wherein the side wall structure frames at least partially an inner volume, and wherein at least a part of the bottom is formed as the in-coupling part, a first part of the side wall structure is formed as the light-transmitting part, a second part of the side wall structure is formed as the partially-transmitting part and a third part of the side wall structure, which is facing away from the bottom, is formed as the out-coupling part.

In various embodiments, in an (optional) method step S2, a front cover is arranged within the inner volume framed at least partially by the side wall structure in a way that at least a part of a side of the in-coupling part that is directed to the out-coupling part is covered by the front cover.

In another method step S3, at the least one (external) light source is arranged adjacent to the in-coupling part of the light guide module on a side of the in-coupling part that is directed away from the out-coupling part of the light guide module. The method step S3 may be performed before or after the method step S2. It is also possible to perform method step S3 without method step S2.

Furthermore, in another method step S4, at least the light guide module (and maybe also the at least one light source) is at least partially surrounded by a housing of the lamp. (The method steps S2 and S3 may be performed before or after the method step S4.)

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A light guide module for a vehicle lamp, the light guide module comprising:
a one-piece body including an in-coupling part formed so that light of at least one external light source is coupled into the in-coupling part;
a light-transmitting part formed adjacent to the in-coupling part such that the light coupled into the in-coupling part is transmitted by total internal reflection through the light-transmitting part away from the in-coupling part;
a partially-transmitting part formed adjacent to the light-transmitting part such that the light transmitted through the light-transmitting part is partially transmitted by total internal reflection through the partially-transmitting part away from the light-transmitting part and is partially emitted on at least one light-emitting partial area of at least one side surface of the partially-transmitting part; and
an out-coupling part formed adjacent to the partially-transmitting part such that the light transmitted through the partially-transmitting part is emitted on an out-coupling surface of the out-coupling part.

2. The light guide module of claim 1, wherein a perimeter of the light guide module increases along a direction from the in-coupling part to the out-coupling part.

3. The light guide module of claim 2, wherein the one-piece body comprises a bottom and a side wall structure,
wherein the side wall structure frames at least partially an inner volume, and
wherein at least a part of the bottom is formed as the in-coupling part, a first part of the side wall structure is formed as the light-transmitting part, a second part of the side wall structure is formed as the partially-transmitting part and a third part of the side wall structure, which is facing away from the bottom, is formed as the out-coupling part.

4. The light guide module of claim 3, wherein a front cover is arranged within the inner volume framed at least partially by the side wall structure such that at least a part of a side of the in-coupling part that is directed to the out-coupling part is covered by the front cover.

5. The light guide module of claim 4, wherein the side wall structure is U-shaped in a cross sectional area parallel to the bottom.

6. The light guide module of claim 3, wherein the side wall structure is U-shaped in a cross sectional area parallel to the bottom.

7. The light guide module of claim 1, wherein at least one of at least one optical prism and at least one grain is formed in the light-transmitting part such that the light transmitted through the light-transmitting part is distributed homogeneously into the partially-transmitting part.

8. The light guide module of claim 1, wherein at least one decorative element is formed as the at least one light-emitting partial area of the at least one side surface of the partially-transmitting part such that the light transmitted through the light-transmitting part is partially emitted on the at least one decorative element.

9. The light guide module of claim 1, wherein the out-coupling surface of the out-coupling part is at least partially formed of or covered with a light-scattering material.

10. The light guide module of claim 1, wherein at least one of the light-transmitting part and the partially-transmitting part are at least partially formed of a clear translucent material.

11. The light guide module of claim 1, wherein the one-piece body comprises a bottom and a side wall structure,
wherein the side wall structure frames at least partially an inner volume, and
wherein at least a part of the bottom is formed as the in-coupling part, a first part of the side wall structure is formed as the light-transmitting part, a second part of the side wall structure is formed as the partially-transmitting part and a third part of the side wall structure, which is facing away from the bottom, is formed as the out-coupling part.

12. A lamp for a vehicle, comprising:
the light guide module according to claim 1;
at least one light source arranged adjacent to the in-coupling part of the light guide module on a side of the in-coupling part that is directed away from the out-coupling part of the light guide module; and
a housing, surrounding the light guide module and the at least one light source at least partially.

13. The lamp of claim 12, wherein the lamp comprises a signal light, a head light, a tail light, a stop light, a turn signal, a reversing light, a rear fog lamp or a position light.

14. A method of manufacturing a light guide module for a vehicle lamp, the method comprising:
forming a one-piece body with an in-coupling part, a light-transmitting part adjacent to the in-coupling part, a partially-transmitting part adjacent to the light-transmitting part and an out-coupling part adjacent to the partially-transmitting part,
wherein the one-piece body is formed so that light of at least one external light source is coupled into the later in-coupling part, the light coupled into the in-coupling part is transmitted by total internal reflection through the later light-transmitting part away from the in-coupling part, the light transmitted through the light-transmitting part is partially transmitted by total internal reflection through the later partially-transmitting part away from the light-transmitting part and is partially emitted on at least one light-emitting partial area of at least one side surface of the partially-transmitting part, and the light transmitted through the partially-transmitting part is emitted on an out-coupling surface of the out-coupling part.

15. The method of claim 14, wherein the one-piece body is formed with a bottom and a side wall structure, wherein the side wall structure frames at least partially an inner volume, and wherein at least a part of the bottom is formed as the in-coupling part, a first part of the side wall structure is formed as the light-transmitting part, a second part of the side wall structure is formed as the partially-transmitting part and a third part of the side wall structure, which is facing away from the bottom, is formed as the out-coupling part.

16. The method of claim 15, wherein a front cover is arranged within the inner volume framed at least partially by the side wall structure such that at least a part of a side of the in-coupling part that is directed to the out-coupling part is covered by the front cover

17. A method of manufacturing a lamp for a vehicle comprising:
manufacturing a light guide module according to the method of claim 14; and
arranging the at least one light source adjacent to the in-coupling part of the light guide module on a side of the in-coupling part that is directed away from the out-coupling part of the light guide module;
wherein the light guide module and the at least one light source are at least partially surrounded by a housing of the lamp.

18. A method of manufacturing a lamp for a vehicle comprising:
manufacturing a light guide module according to the method of claim 15; and
arranging the at least one light source adjacent to the in-coupling part of the light guide module on a side of the in-coupling part that is directed away from the out-coupling part of the light guide module;
wherein the light guide module and the at least one light source are at least partially surrounded by a housing of the lamp.

19. A method of manufacturing a lamp for a vehicle comprising:
manufacturing a light guide module according to the method of claim 15; and
arranging the at least one light source adjacent to the in-coupling part of the light guide module on a side of the in-coupling part that is directed away from the out-coupling part of the light guide module;
wherein the light guide module and the at least one light source are at least partially surrounded by a housing of the lamp.

20. A method of manufacturing a lamp for a vehicle comprising:
manufacturing a light guide module according to the method of claim 16; and
arranging the at least one light source adjacent to the in-coupling part of the light guide module on a side of the in-coupling part that is directed away from the out-coupling part of the light guide module;
wherein the light guide module and the at least one light source are at least partially surrounded by a housing of the lamp.
